(19) United States
(12) Patent Application Publication
(10) Pub. No.: US 2007/0169471 A1
(43) Pub. Date: Jul. 26, 2007

(54) Vehicle steering mechanism

(75) Inventor: Peter Rieth, Keilstrasse 3, 65343 Etrville (DE)

Correspondence Address: CONTINENTAL TEVES, INC., ONE CONTINENTAL DRIVE, AUBURN HILLLS, MI, 48326-1581, US

(73) Assignee: CONTINENTAL TEVES AG & CO., OHG, FRANKFURT GERMANY (DE)

(21) Appl. No.: 10/588,983

(22) PCT Filed: Feb. 8, 2005
(86) PCT No.: PCT/EP05/50535

§ 371 Date: Aug. 10, 2006

(30) Foreign Application Priority Data
Feb. 10, 2004 (DE) 10-2004-006-581.0

(51) Int. Cl. F16D 31/02

(52) U.S. Cl. 60/384

(57) ABSTRACT

In a vehicle steering mechanism for motor vehicles, with a steering handle that can be operated by the driver, as well as a positioning assembly coordinated with the steered vehicle wheels, which assembly is effectively connected with the steering handle and by means of which assembly the steered vehicle wheels can be swiveled by additional elements in order to set a specifically desired steering angle, and which positioning assembly is a hydraulic assembly with two hydraulic chambers which are divided by a hydraulic piston and can be stressed by the pressure of a hydraulic pressure source, the hydraulic assembly can be connected with the hydraulic pressure source or with a pressure medium supply container, as the case may be, via a valve unit, and a steering support can be adjusted by means of the valve unit.

### BACKGROUND OF THE INVENTION

The invention relates to a vehicle steering mechanism for motor vehicles with a steering handle that can be operated by the driver, as well as a positioning assembly coordinated with the steered vehicle wheels, which assembly is effectively connected with the steering handle and by means of which assembly the steered vehicle wheels can be swiveled by means of additional elements, such as tie rods and a steering arm, for example, in order to set a specifically desired steering angle, if necessary, and which positioning assembly is a hydraulic assembly with two hydraulic chambers which are divided by a hydraulic piston and can be stressed by the pressure of a hydraulic pressure source.

The provision of a vehicle steering mechanism of the type stated above, by means of which an effective steering angle control with a high functional reliability is achieved, forms the objective of the invention.

The invention solves this problem through the provision of a vehicle steering mechanism with the characteristics of a hydraulic assembly that can be connected with the hydraulic pressure source or with a pressure medium supply container, as the case may be, by a valve unit, and that, a steering support can be adjusted via the valve unit.

### SUMMARY OF THE INVENTION

It is essential for the invention for the hydraulic assembly to be able to be connected with the hydraulic pressure source or with a pressure medium supply container, as the case may be, by means of a valve unit, and for a steering support to be able to be adjusted by means of the valve unit.

It is provided in accordance with the invention that the valve unit has a hydraulic slide valve, by means of which a steering support is controlled by means of the continuous adjustment of a difference in pressure between the two hydraulic chambers. A particularly comfortable adjustment of the supporting pressure is guaranteed by means of this continuous controllability of the slide valve in the sense of a “hydraulic full bridge”.

It is provided in accordance with the invention that the valve unit is a continuously adjustable slide valve with three final switching positions, with a first final switching position, in which a pressure medium can be introduced into the two hydraulic chambers and/or removed from the two hydraulic chambers, so that the pressure difference between the two hydraulic chambers amounts to “0” (ZERO), with a second final switching position, in which the pressure medium can be introduced into a first hydraulic chamber and removed from a second hydraulic chamber, and with a third final switching position, in which the pressure medium can be removed from the first hydraulic chamber and introduced into the second hydraulic chamber in order to set a maximum supporting pressure.

It is provided in accordance with the invention that the hydraulic slide valve of an electrical actuator can be continuously adjusted between the different final switching positions through the linear movement of a valve gate, preferably by means of a servodrive unit and a gear or electromagnet, if applicable. A linear movement or an “adjusting movement” of the valve gate is produced by the electrical actuator, by means of which this [valve gate] can be brought into any “preferred” displacement positions, so that a continuous control of the pressure is brought about.

In accordance with the invention, a distance sensor is provided for the hydraulic slide valve, by means of which [sensor] the linear movement of the valve gate is determined.

It is also provided in accordance with the invention that the hydraulic slide valve has control edges, by means of which a pressure difference between the two hydraulic chambers is adjusted continuously during a linear movement of the valve gate. The control edges thereby have a special configuration, so that a harmonic pressure amplification function and a good control behavior are achieved for the steering support.

It is also provided in accordance with the invention that the valve unit has, in an alternate manner, at least four analogized valves, preferably 2 flow-free closed (SG) and 2 flow-free open (SO) analogue valves, or valves which can be operated in an analogous manner, for the purpose of controlling the pressure in both of the hydraulic chambers.

In accordance with the invention, a safety valve is provided, by means of which the two hydraulic chambers can be directly connected with one another. In the event of failure, the chambers can thereby be connected directly, so that a closed hydraulic circuit arises, by means of which the wheels can be controlled directly by means of the steering wheel—that is to say, in this case, without support.

In accordance with the invention, a hydraulic slide valve, which can be switched into different switching positions by means of 2 hydraulic valves through a linear movement of a safety valve switching element, is provided as a safety valve.

In accordance with the invention, 2 hydraulic pressure sensors are provided, by means of which the hydraulic pressure in the 2 hydraulic chambers is determined, and it is provided that a steering support can be adjusted in accordance with the pressures determined.

In accordance with the invention, a torque sensor is provided, which determines the torque on a steering wheel shaft of the vehicle steering mechanism. It is provided that a steering support can be adjusted in accordance with the torques determined.

It is provided in accordance with the invention that the steering mechanism is a steering mechanism with an open center (/given in English/: “open center steering mechanism”) in which, in a neutral position of the steering mechanism—that is to say, with the steering wheel in the straight-ahead position—, essentially no pressure difference is present between the chambers divided by the hydraulic piston, and that the hydraulic pressure source has a pump which is connected with the drive motor of the motor vehicle by means of a drive unit, preferably a belt drive unit.

It is provided in accordance with the invention that the steering mechanism is a steering mechanism with a closed center (/English/: “closed center steering mechanism”) in which, in a neutral position of the steering mechanism—that is to say, with the steering wheel in the straight-ahead position—, a hydraulic pressure or a pressure difference can essentially be present in the chambers divided by the hydraulic piston, and that the hydraulic pressure source has a pump which can be connected with the motor vehicle drive unit by means of a coupling unit and by means of a drive unit, preferably a belt drive.

It is provided in accordance with the invention that the hydraulic pressure source has a high pressure reservoir, and that the pump is operated in order to load the high pressure reservoir.

A hydraulic pressure sensor is provided in accordance with the invention, whereby the hydraulic pressure in the high pressure reservoir is determined by means of the pressure sensor.

The analogue valves or analogized valves that are preferred for the vehicle steering mechanism in accordance with the invention are proportional valves. These are, in particular, proportionally controlled or operated magnetic valves or piezovalves. Seat valves, such as 2/2-way valves with two inlets and/or outlets, are particularly used as magnetic valves, whereby the inlets or outlets, respectively, are connected with one another in the one (opened) switching position, and are divided from one another in the other (closed) switching position.

The opening and closing of the magnetic valves is brought about through the activation or deactivation, respectively, of a magnet provided in the valve. The activation of the magnet, which means the flowing of current through the coil, brings about the movement or, stated more precisely, the tightening or the releasing of an armature which is connected with the closing mechanism of the valve, and thereby jointly moves this.

Through the proportional activation in accordance with the invention, these valves are operated in such a manner that the closing mechanism occupies an intermediate position between the switching positions, or they are opened or closed in rapid succession for the same or different lengths of time, so that a condition corresponding to a stationary intermediate position of the closing mechanism is thereby set. By means of such a type of adjustment of the valve, a specific differential pressure can be set in the vehicle steering mechanism in accordance with the invention by means of the valve.

By means of the steering mechanism in accordance with the invention, a swiveling of the steerable wheels can in principle also be brought about independently of the driver by means of an amplification function, such as, for example, in order to react faster and better (than the driver) during perceived emergency situations, such as instabilities of the motor vehicle. In addition, comfort functions, such as a necessary steering force dependent on the motor vehicle speed, in the sense of a parameter steering, can be achieved in a simple manner.

The design and function of the vehicle steering mechanism in accordance with the invention will now be illustrated in further detail by way of example by means of the diagrams (FIG. 1 to 6).

### BRIEF DESCRIPTION OF THE DRAWINGS

In the figures:

FIG. 1: Depicts a steering system with hydraulic steering support from a hydraulic pump driven by the drive motor of the motor vehicle.

FIG. 2: Depicts a form of implementation of a steering mechanism with an open center in accordance with the invention, with a valve unit with a linear slide valve (servovalve), a safety valve, and two pressure sensors.

FIG. 3: Depicts an additional form of implementation of a steering mechanism with an open center in accordance with the invention, with a distance sensor on the actuator of a linear slide valve of the valve unit.

FIG. 4: Depicts a form of implementation of a steering mechanism with an open center in accordance with the invention, with a valve unit with four analogized valves.

FIG. 5: Depicts a form of implementation of a steering mechanism with a closed center in accordance with the invention, with a valve unit with four analogized valves and a high pressure reservoir.

FIG. 6: Depicts the valve unit in accordance with the invention, with a linear slide valve and a safety valve in the closed switching position, in a schematic representation.

FIG. 7: Depicts the valve unit depicted in FIG. 8 in a cross-section.

FIG. 8: Depicts the valve unit in accordance with the invention, with a linear slide valve and a safety valve in the open switching position, in a schematic representation.

FIG. 9: Depicts the valve unit depicted in FIG. 10 in a cross-section.

### DETAILED DESCRIPTION OF THE DRAWINGS

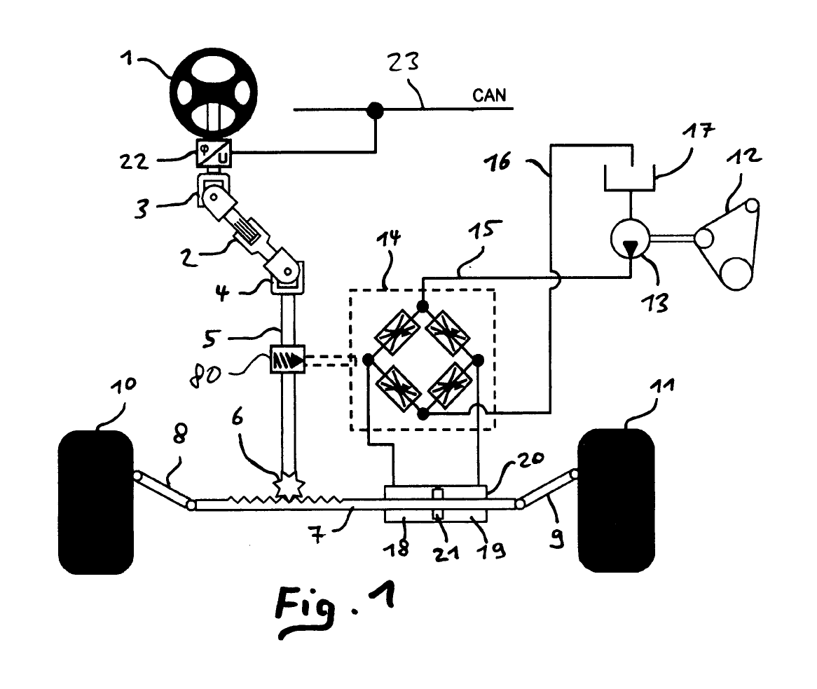

The steering system depicted in FIG. 1 consists of a steering wheel 1 and of a steering column 2 connected with the steering wheel 1, with 2 cardan joints 3, 4. The steering column 2 is connected [with] or is part of a steering wheel shaft 5, which [shaft], by means of a steering gear 6, actuates a steering rod 7, which is configured here as a toothed rack 7, which [toothed rack] actuates tie rods 8, 9 attached laterally to the toothed rack 7 and thereby brings about a swiveling of the wheels 10, 11. In the toothed rack steering mechanism depicted here, a hydraulic support is brought about by means of a hydraulic pump 13 driven by the drive motor of the motor vehicle, such as by means of a belt drive 12, for example, which [pump] supplies the pressure fluid placed under pressure to a steering valve 14 by way of a line 15. The pressure fluid can flow back into a supply container 17 through a return pipe 16.

In the straight-ahead position of the steering wheel, a constant stream of oil flows through the steering valve placed in the neutral position (open center) and back through the return pipe 16. The pressure in 2 chambers 18, 19 of a work cylinder 20 positioned on the toothed rack 7, which [chambers] are divided by a piston 21, is then equally great. No steering support is brought about.

Upon the turning of the steering wheel 1, the toothed rack 7 is displaced by means of the torsion bar 80 and the steering gear mechanism 6. The movement of the piston 21 is supported by the pressure of the pressure fluid. The valve 14 thereby brings it about that pressure fluid flows from one chamber into the other chamber, so that the actuation of the steering has hydraulic support. The actuation of the steering wheel 1 can be measured by a steering angle sensor 22, and the signal of the same can be transmitted to an electronic unit, preferably by means of a motor vehicle bus system (CAN) 23.

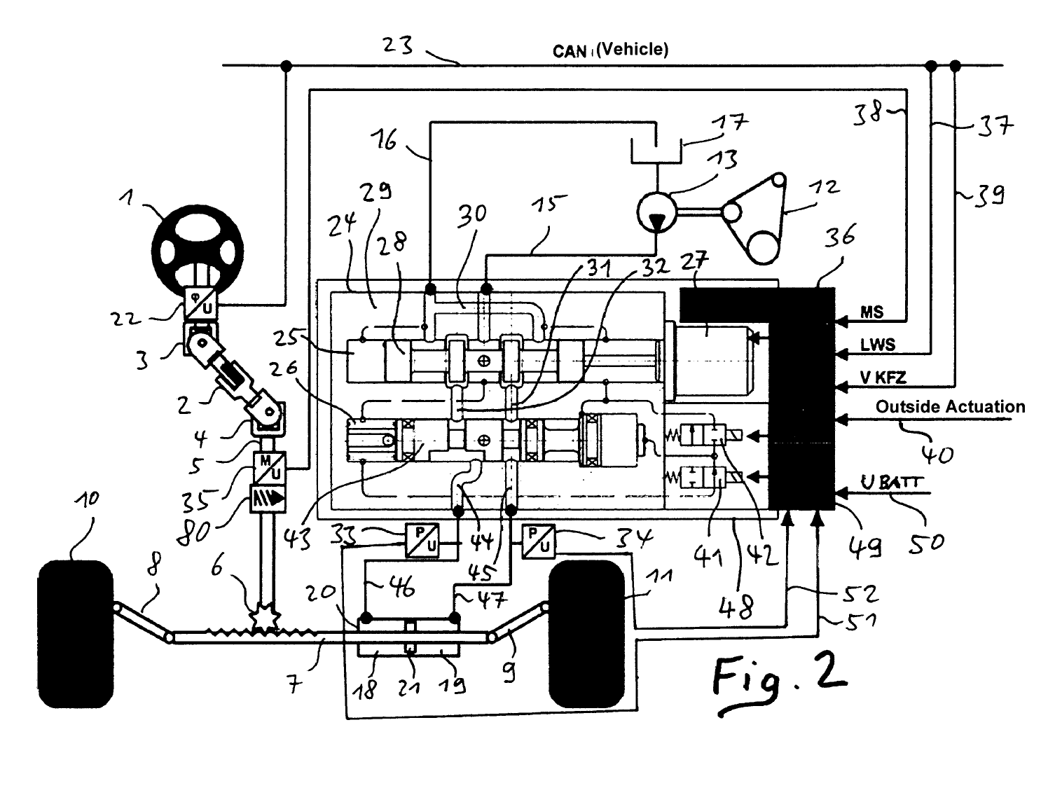

FIG. 2 depicts a form of implementation of a steering mechanism with an open center in accordance with the invention. Equivalent parts of the steering mechanism are also provided with the same reference figures as in FIG. 1, both here and in the following.

In this form of implementation, a valve unit 24, which has a hydraulic linear slide valve 25 and a safety valve 26, is provided. The linear switching valve 25 is actuated by an electrical actuator 27, preferably by means of a servomotor and a gear mechanism. A valve gate 28 is thereby placed into different slide unit positions. In cooperation with control edges of the valve gate 28 and borings 30, 31, 32 in a block of the valve unit 24, three final switching positions are made possible for the valve block 29 through the linear movement of the linear slide valve 25: a first final switching position, in which a pressure medium can be introduced into the two hydraulic chambers 18, 19 and/or removed from the two hydraulic chambers 18, 19, so that no pressure difference arises between the two chambers (middle position); a second final switching position, in which the pressure medium can be introduced into the first hydraulic chamber 18 and can be removed from the second hydraulic chambers 19; and, a third final switching position, in which the pressure medium can be removed from the first hydraulic chamber 18 and can be introduced into the second hydraulic chamber 19, so that a maximum pressure difference is formed between the pressures in the two hydraulic chambers, whereby the pressure difference between these final positions can be adjusted continuously.

For the control of the differential pressure between the pressures, two hydraulic pressure sensors 33, 34 are positioned in both hydraulic chambers, by means of which [sensors] the hydraulic pressure is determined in both of the hydraulic chambers 18, 19. In addition, a torque sensor 35, which determines the torque on a steering wheel shaft 5 of the vehicle steering mechanism, is provided. The torque sensor 35 essentially serves for the production of a nominal value default for the control of the differential pressure. The control of the steering support is carried out by means of an electronic unit, the ECU 36, in accordance with the steering wheel angle 37 determined, the torque 38 determined on the steering wheel shaft 5, the speed of the motor vehicle, or the reference speed 39 motor vehicle as determined by a brake control system, as the case may be, as well as in accordance with additional influencing variables, such as outside actuation 40 by means of driving stability control, for example, or by means of supplemental systems for the maintenance of driving lanes or for parking processes, if necessary.

A hydraulic slide valve, which can be switched into different switching positions by means of two hydraulic switching valves 41, 42 through a linear movement of a safety valve-switching element 43 and in cooperation with the borings 31, 32, 44, 45, is likewise provided as a safety valve 26. By means of the safety valve 26, the two hydraulic chambers 18, 19 can be connected directly with one another by way of the borings 44, 45 and connecting lines 46, 47. The function of the vehicle steering mechanism is guaranteed (without steering support) even in the event of a failure of the supporting function or of the actuator technology of the steering support.

The valve unit 24 is preferably combined with the switching valves 41, 42 and the actuator 27 in a hydraulic unit 48, whereby the pressure sensors 33, 34 (not depicted here) can also be integrated into the same. An electronics block 49 with the interfaces to the signals 37-40 and with the ECU 36 is preferably positioned on the hydraulic unit 48. The electronics block 49 is provided with power by the on-board power supply (supply voltage UBATT 50).

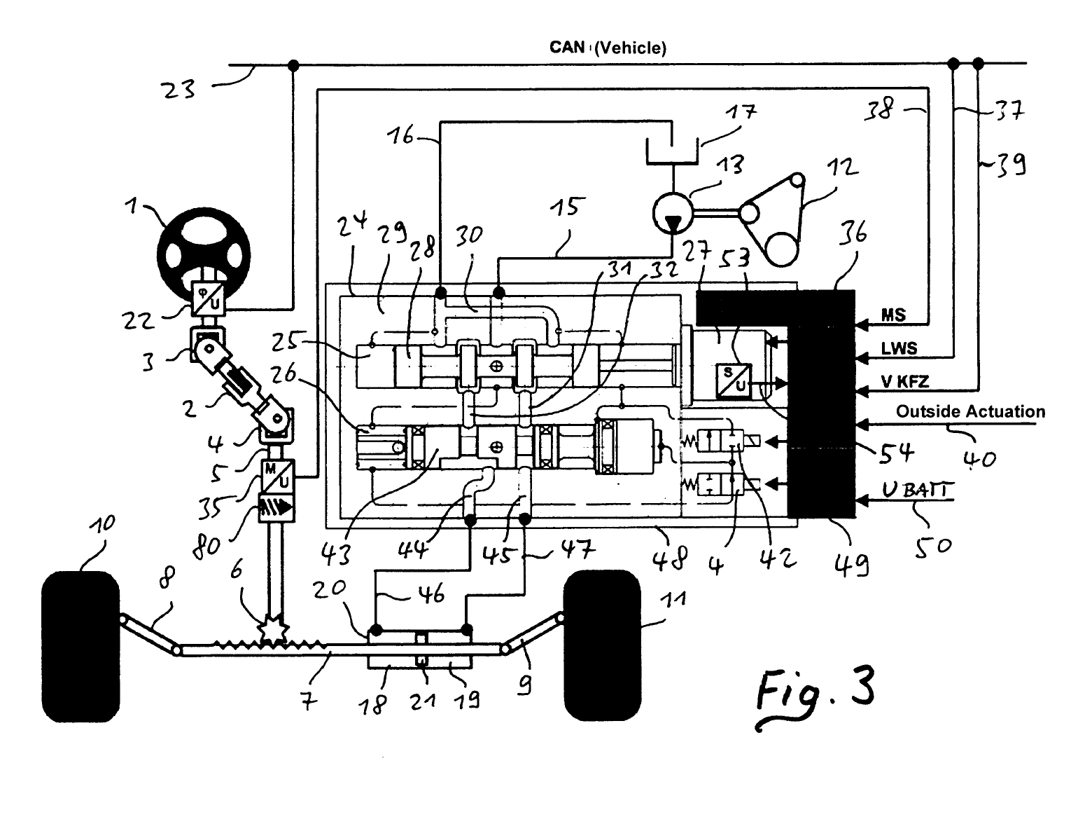

FIG. 3 depicts an additional form of implementation of a steering mechanism with an open center in accordance with the invention. In distinction to the form of implementation depicted in FIG. 2, the control of the pressure is not carried out here in accordance with pressure sensor signals (51, 52 in FIG. 2), but a linear path sensor 53 is instead provided on the actuator 27. The hydraulic pressures in the chambers 18, 19 are determined or estimated, as the case may be, on the basis of the distance of the path of the slide unit 29 of the linear slide valve 25 that is measured, and are used for the control of the steering support 54.

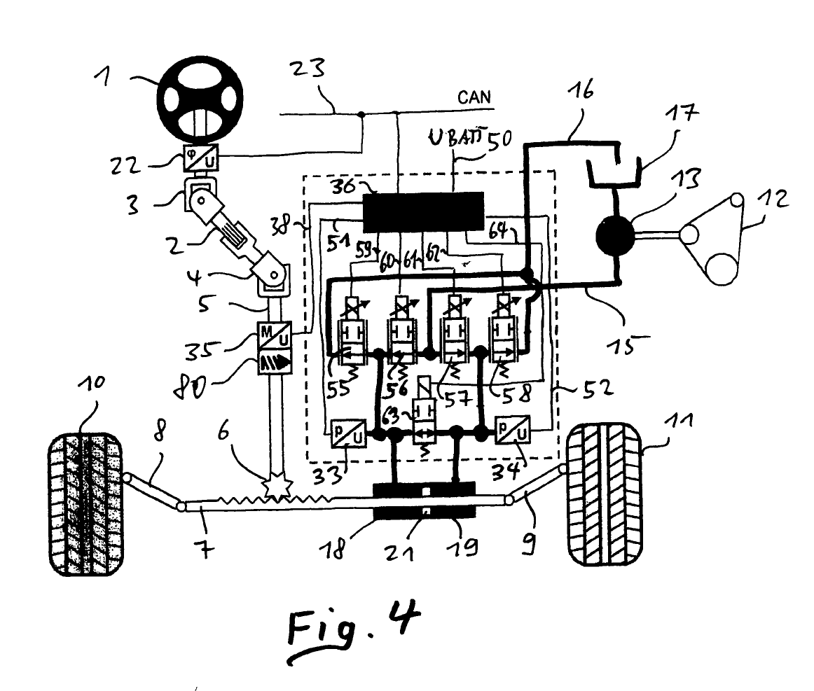

FIG. 4 depicts an additional form of implementation of a steering mechanism with an open center in accordance with the invention, which has a valve unit with four analogized valves 55, 56, 57, 58, which [valves] are, for the purpose of the control of the pressure in both of the hydraulic chambers 18, 19, activated 59, 60, 61, 62 by the ECU 36. In addition, a switching valve 63, by means of which the two hydraulic chambers can be connected directly with one another, is provided as a safety valve. The switching valve 63 is likewise actuated 64 by the ECU 36.

FIG. 5 depicts a form of implementation of a steering mechanism with a closed center in accordance with the invention, which is similar to the design depicted in FIG. 4, and likewise has four analogue valves 65-58.

Furthermore, for the “closed center” design, a high pressure reservoir 69 is provided for the pressure medium. Because of the high pressure reservoir 69, a power supply is advantageously always present for the support of the steering. The storage unit 69 is only loaded by means of the pump 13 if the pressure drops below a lower boundary value—in this case, approx. 120 bar. The loading is advantageously carried out up to a maximum pressure of approx. 180 bar. Thus, the pump 13 is integrated into the drive unit by means of a coupling unit 70—in this case, by means of a belt drive. The coupling unit 70 can advantageously be designed with the pump 13 as a construction module. Here, the control is carried out by means of an additional pressure sensor 71, which measures the pressure in a high pressure reservoir and conveys 72 the same to the ECU 36.

It is particularly advantageous to provide two flow-free closed (SG) 66, 67 and two flow-free open (SO) 65, 68 analogue valves, or valves which can be operated in an analogous manner, as control valves 65-68, in order to control the pressure in both of the hydraulic chambers.

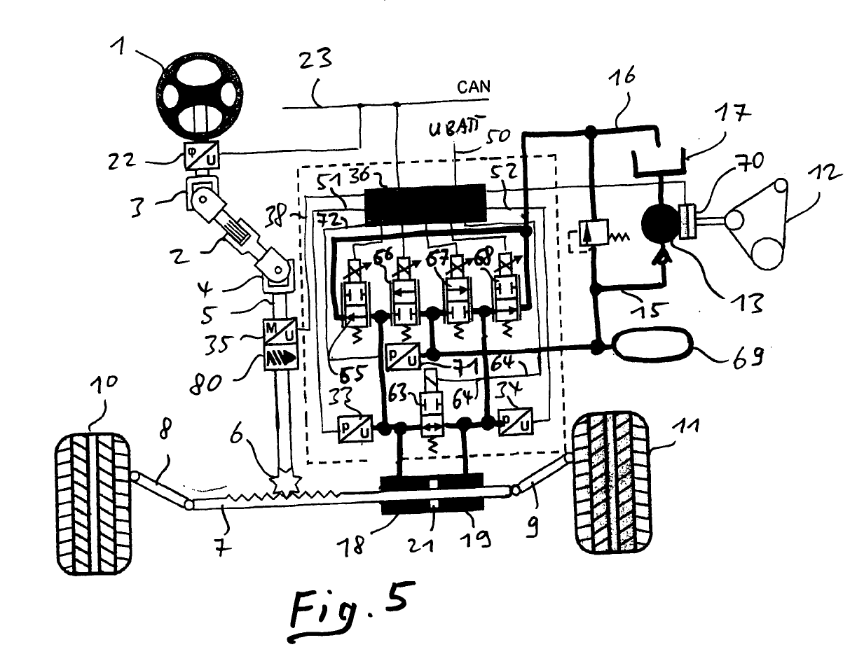

The safety concept is depicted in further detail in FIG. 6 to FIG. 9 by way of an example.

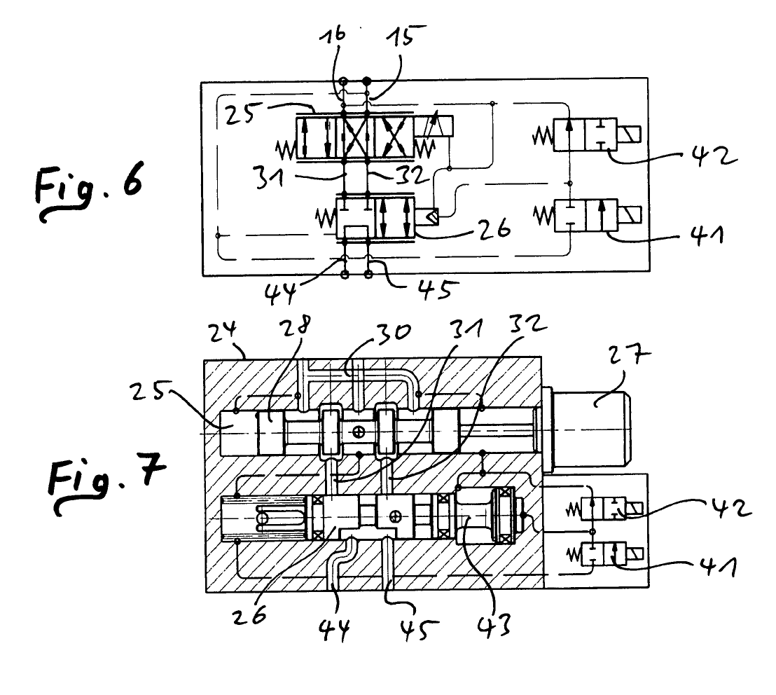

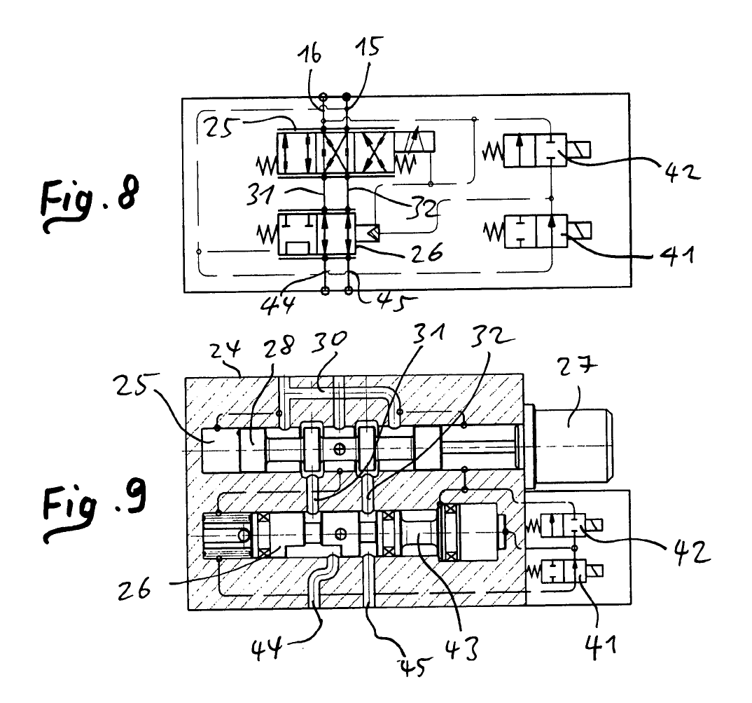

FIG. 6 thereby depicts the valve unit in accordance with the invention, with a linear slide valve 25 and a safety valve 26 in the closed switching position, in a schematic representation, and FIG. 7 depicts the valve unit 24 depicted in FIG. 8 in a cross-section. The hydraulic unit 48 with the valve unit 24 corresponds to the form depicted in FIGS. 2 and 3 and described above.

The linear switching valve 25 is positioned in the first final switching position (middle position), in which the pressure medium can be introduced into the two hydraulic chambers 18, 19 and/or can be removed from the two hydraulic chambers 18, 19. This middle position is automatically assumed by the valve gate by means of an elastic element, particularly a spring, if the actuator does not set any specific position. An activation of the steering mechanism (without servo-support) is thereby ensured in the event of an error.

The safety valve 26 in the figure is positioned in the flow-free switching position. This means that both of the switching valves 41, 42 are not flowed through here. The safety valve 26 is thereby closed. This represents, at the same time, an instance of failure. In this case, the connecting lines 44, 45 to the hydraulic chambers 18, 19 are connected with one another. A system error in the amplification function of the steering mechanism then leaves the basic steering function (without amplification of the steering) of the vehicle steering mechanism uninfluenced.

FIGS. 8 and FIG. 9 correspond to the representation in FIG. 6 and FIG. 7, whereby the safety valve 26 is shown here in the open switching position. In addition, the switching valves 41, 42 are flowed through.

The linear slide valve 25 is positioned, as in FIG. 6 and FIG. 7, in the first slide unit position (middle position). Since the safety valve 26 is now open, the hydraulic chambers 18, 19 are not directly connected with one another. An amplification function of the steering mechanism can be adjusted by means of the displacement of the linear slide valve 25, whereby a (controllable) differential pressure arises between the individual chambers 18, 19.

The vehicle steering mechanism in accordance with the invention can advantageously use the conventional toothed rack steering mechanism. Since—in contrast to conventional hydraulic steering devices, in which the rotary slide unit/steering valve is not coupled by way of the torsion bar—a mechanically decoupled steering valve or valves are provided here, the steering support can also be operated remotely. In this case, for example, an actuator (electromechanical transformer) is controlled in a translational manner corresponding to a controller default, and brings about a corresponding actuation of the valve that is desired.

1-15. (canceled)

16. A vehicle steering mechanism for motor vehicles, the mechanism comprising:
a steering handle that can be operated by a driver;
a positioning assembly coordinated with steered vehicle wheels, wherein the assembly is effectively connected with the steering handle and the steered vehicle wheels can be swiveled by use of additional elements, such as tie rods and a steering arm, in order to set a specifically desired steering angle, and the positioning assembly is a hydraulic assembly with two hydraulic chambers which are divided by a hydraulic piston and can be stressed by pressure of a hydraulic pressure source; and
a valve unit, wherein the hydraulic assembly can be connected with the hydraulic pressure source or with a pressure medium supply container by the valve unit, and a steering support can be adjusted by the valve unit.

17. A vehicle steering mechanism according to claim 16, wherein the valve unit has a hydraulic slide valve by which a steering support is controlled through a continuous adjustment of a pressure difference between the two hydraulic chambers.

18. A vehicle steering mechanism according to claim 17, wherein the valve unit is a continuously adjustable slide valve with three final switching positions, with a first final switching position in which a pressure medium can be introduced into the two hydraulic chambers or can be removed from the two hydraulic chambers, with a second final switching position, in which the pressure medium can be introduced into a first hydraulic chamber and can be removed from a second hydraulic chamber, and with a third final switching position, in which the pressure medium can be removed from the first hydraulic chamber and can be introduced into the second hydraulic chamber.

19. A vehicle steering mechanism according to claim 18, the hydraulic slide valve of an electrical actuator can be continuously adjusted between the different final switching positions through a linear movement of a valve gate, preferably by means of a servodrive unit and a gear or electromagnet, if applicable.

20. A vehicle steering mechanism according to claim 19, wherein a distance sensor is provided for the hydraulic slide valve, and the sensor is used to determine linear movement of the valve gate.

21. A vehicle steering mechanism according to claim 17, wherein the hydraulic slide valve has control edges, by which a specific pressure difference between the two hydraulic chambers is adjusted continuously during a linear movement of the valve gate.

22. A vehicle steering mechanism according to claim 16, wherein the valve unit has at least four analogized valves, preferably 2 flow-free closed (SG) and 2 flow-free open (SO) analogue valves, or valves which can be operated in an analogous manner, for the purpose of controlling the pressure in both of the hydraulic chambers.

23. A vehicle steering mechanism according to claim 16, wherein a safety valve is provided for directly connecting the two hydraulic chambers with one another.

24. A vehicle steering mechanism according to claim 23, wherein a hydraulic slide valve, which can be switched into different switching positions by two hydraulic valves through a linear movement of a safety valve switching element, is provided as a safety valve.

25. A vehicle steering mechanism according to claim 16, wherein two or more hydraulic pressure sensors are provided for determining the hydraulic pressure in the two or more hydraulic chambers, and a steering support can be adjusted in accordance with the determined pressures.

26. A vehicle steering mechanism according to claim 16, wherein a torque sensor is provided, which determines the torque on a steering wheel shaft of the vehicle steering mechanism, and a steering support can be adjusted in accordance with the determined torques.

27. A vehicle steering mechanism according to claim 16, wherein the steering mechanism is a steering mechanism with an open center in which, in a neutral position of the steering mechanism, such as when the steering wheel is in the straight-ahead position, essentially no pressure difference is present between the chambers divided by the hydraulic piston, and the hydraulic pressure source has a pump which is connected with the drive motor of the motor vehicle via a drive unit.

28. A vehicle steering mechanism according to claim 16, the steering mechanism is a steering mechanism with a closed center in which, in a neutral position of the steering mechanism a hydraulic pressure or a pressure difference can essentially be present in the chambers divided by the hydraulic piston, and the hydraulic pressure source has a pump which can be connected with the motor vehicle drive unit via a coupling unit and by a drive unit.

29. A vehicle steering mechanism according to claim 28, wherein the hydraulic pressure source has a high pressure reservoir, and the pump is operated in order to load the high pressure reservoir.

30. A vehicle steering mechanism according to claim 29, wherein a hydraulic pressure sensor is provided, and the hydraulic pressure in the high pressure reservoir is determined by the pressure sensor.
